(19) United States
(12) Patent Application Publication
(10) Pub. No.: US 2025/0253636 A1
(43) Pub. Date: Aug. 7, 2025

(54) VEHICLE FRONT PORTION STRUCTURE

(71) Applicant: TOYOTA JIDOSHA KABUSHIKI KAISHA, Toyota-shi (JP)

(72) Inventor: Koji AMEMIYA, Okazaki-shi (JP)

(21) Appl. No.: 18/974,786

(22) Filed: Dec. 10, 2024

(30) Foreign Application Priority Data
Feb. 7, 2024 (JP) 2024-017208

(51) Int. Cl. H02G 3/32; B60R 13/02; B60R 16/02; B62D 25/08; B62D 29/04

(52) U.S. Cl. CPC H02G 3/32; B60R 13/0256; B60R 16/0215; B62D 25/082; B62D 29/043

(57) ABSTRACT

A vehicle front portion structure, includes a dash panel that is made of a resin and that partitions a power unit room of a vehicle from a vehicle cabin; and a clamp that is integrally formed with the dash panel and that holds a wire harness that is arranged at the dash panel.

### CROSS-REFERENCE TO RELATED APPLICATION

This application claims priority under 35 USC 119 from Japanese Patent Application No. 2024-017208, filed Feb. 7, 2024, the disclosure of which is incorporated by reference herein in its entirety.

### BACKGROUND

### Technical Field

The present disclosure relates to a vehicle front portion structure.

### Related Art

In WO 2011/155238, a bracket is fixed to a dash panel and a harness cover is attached via the bracket to the dash panel, and a wire harness is attached to and detached from the wire harness.

### SUMMARY

However, in the configuration described in WO 2011/155238, a stud bolt is fixed to the dash panel, the stud bolt is inserted into an insertion hole that is formed in the bracket, and a nut is screwed in, thereby fixing the bracket to the dash panel.

Namely, in this prior art, when arranging a wire harness at a dash panel, there is a large number of components, and the number of work man-hours increases correspondingly.

In consideration of the above-mentioned circumstances, the present disclosure provides a vehicle front portion structure that is capable of achieving a reduction in the number of components when arranging a wire harness at a dash panel.

### Means for Solving the Problem

A vehicle front portion structure according to a first aspect of the present disclosure includes: a dash panel made of a resin and partitioning a power unit room from a vehicle cabin; and a clamp t integrally formed with the dash panel and holding a wire harness that is arranged at the dash panel.

The vehicle front portion structure according to the first aspect includes a dash panel and a clamp. The dash panel is formed of a resin, and partitions the power unit room from the vehicle cabin. The clamp is integrally formed with the dash panel, and holds the wire harness that is arranged at the dash panel.

In the vehicle front portion structure according to the first aspect, the clamp is integrally formed (so-called integrally molded) at the dash panel that is made of a resin, such that auxiliary materials such as studs, which are used when the clamp is attached to the dash panel, are unnecessary, and the number of components can be reduced. Moreover, since a process of attaching the clamp to the dash panel is unnecessary, the number of work man-hours can be reduced, enabling a cost reduction to be achieved.

A vehicle front portion structure according to a second aspect of the present disclosure is the vehicle front portion structure according to the first aspect, wherein the clamp stands up from a surface at a vehicle cabin side of the dash panel and holds, together with the surface of the dash panel, the wire harness.

In the vehicle front portion structure according to the second aspect, the clamp stands up from the surface at the vehicle cabin side of the dash panel and holds, together with the surface of the dash panel, the wire harness, thereby enabling the wire harness to be arranged along the surface of the dash panel.

A vehicle front portion structure according to a third aspect of the present disclosure is the vehicle front portion structure according to the first aspect, wherein the clamp includes: a first claw portion that holds the wire harness between the first claw portion and a surface of the dash panel; and a second claw portion that is formed facing the first claw portion, and a gap, through which the wire harness can pass, is provided between the second claw portion and the first claw portion.

In the vehicle front portion structure according to the third aspect, the clamp includes the first claw portion and the second claw portion, and the first claw portion holds the wire harness between the first claw portion and the surface of the dash panel. The second claw portion is formed facing the first claw portion, and a gap, through which the wire harness can pass, is provided between the second claw portion and the first claw portion.

Namely, the wire harness is guided toward a first claw portion side through the gap provided between the first claw portion and the second claw portion, and the wire harness is held between the first claw portion and the surface of the dash panel. Therefore, in holding the wire harness at the clamp, the wire harness is simply passed through the gap that is formed between the first claw portion and the second claw portion, such that the wire harness is easily attached and workability is excellent.

A vehicle front portion structure according to a fourth aspect of the present disclosure is the vehicle front portion structure according to the third aspect, wherein: the second claw portion is formed projecting out from the surface of the dash panel further than the first claw portion; and the gap is deformed between the second claw portion and the first claw portion by elastic deformation of the second claw portion.

In the vehicle front portion structure according to the fourth aspect, the second claw portion is formed projecting out from the surface of the dash panel further than the first claw portion. Therefore, the second claw portion is easier to be elastically deformed than the first claw portion. Further, the gap through which the wire harness can pass is deformed between the second claw portion and the first claw portion by elastic deformation of the second claw portion.

Therefore, when the wire harness passes between the second claw portion and the first claw portion, the second claw portion is restored, and the size of the gap formed between the second claw portion and the first claw portion, through which the wire harness can pass, is at least reduced. As a result, the wire harness is prevented from being pulled out, and the wire harness that is held by the first claw portion can be prevented from being easily detached from the clamp.

A vehicle front portion structure according to a fifth aspect of the present disclosure is the vehicle front portion structure according to the third aspect, wherein a path, through which the wire harness passes, is formed in a labyrinth structure between a leading end portion of the first claw portion and a leading end portion of the second claw portion.

In the vehicle front portion structure according to the fifth aspect, a labyrinth structure is formed between the leading end portion of the first claw portion and the leading end portion of the second claw portion, and a path of the wire harness is changed in the process until the wire harness is inserted and held. This enables the wire harness that is held by the first claw portion not to be easily detached, even if the clamp is bent due to aging or the like.

As explained above, the vehicle front portion structure according to the present disclosure enables the number of components to be reduced when arranging a wire harness at the dash panel.

### BRIEF DESCRIPTION OF THE DRAWINGS

FIG. 1A is an enlarged cross-section view of relevant portions, illustrating a dash panel and a clamp in which relevant portions of a vehicle front portion structure according to an exemplary embodiment of the present disclosure are enlarged;

FIG. 1B is an enlarged cross-section view of relevant portions, for illustrating operation of a clamp according to an exemplary embodiment of the present disclosure;

FIG. 2A is an enlarged cross-section view of relevant portions, illustrating a clamp configuring part of a vehicle front portion structure according to a modified example of an exemplary embodiment of the present disclosure;

FIG. 2B is an enlarged cross-section view of relevant portions, illustrating a clamp configuring part of a vehicle front portion structure according to an exemplary embodiment of the present disclosure;

FIG. 3A is an enlarged cross-section view of relevant portions, for illustrating operation of a clamp configuring part of a vehicle front portion structure according to an exemplary embodiment of the present disclosure;

FIG. 3B is an enlarged cross-section view of relevant portions, for illustrating operation of a clamp configuring part of a vehicle front portion structure according to an exemplary embodiment of the present disclosure; and

FIG. 4 is an enlarged cross-section view of relevant portions, illustrating a comparative example.

### DETAILED DESCRIPTION

Explanation follows regarding a vehicle front portion structure according to an exemplary embodiment of the present disclosure, with reference to the drawings. It should be noted that in each of the drawings, as appropriate, the arrow FR and the arrow UP respectively indicate a frontward direction and an upward direction in a vehicle front-rear direction. Unless specifically stated otherwise, simple reference to the front and rear, up and down, and left and right directions refers to front and rear in the vehicle front-rear direction, up and down in a vehicle up-down direction, and left and right in a case of facing a vehicle frontward direction.

### Configuration of the Vehicle Front Portion Structure

First, explanation follows regarding a configuration of a vehicle front portion structure according to the present exemplary embodiment.

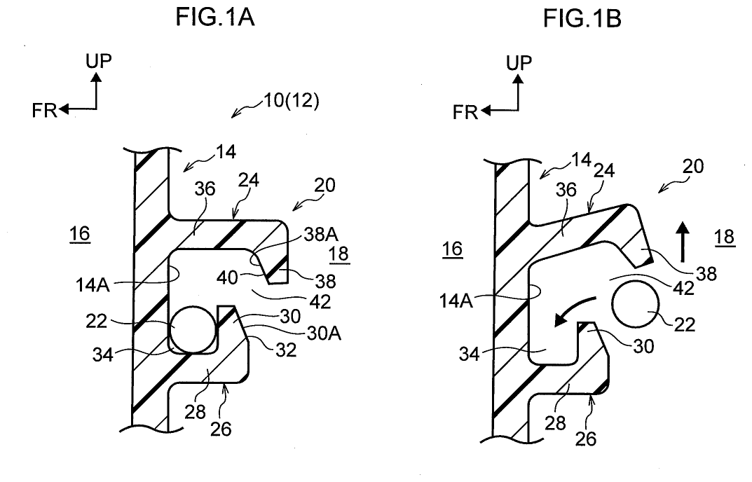

FIG. 1A illustrates an enlarged cross-section view of relevant portions of a dash panel 14 that is provided at a front portion of a vehicle 12 to which a vehicle front portion structure 10 according to the present exemplary embodiment has been applied. As illustrated in FIG. 1A, a power unit room 16 is provided at the front portion of the vehicle 12, and a vehicle cabin 18 (cabin) is provided at a rear side of the power unit room 16. The dash panel 14 is provided between the vehicle cabin 18 and the power unit room 16. The dash panel 14 extends in the up-down direction and a width direction with the front-rear direction as a plate thickness direction, and the vehicle cabin 18 and the power unit room 16 are partitioned by the dash panel 14.

### Clamp

The dash panel 14 is formed in a plate shape by a resin, and a clamp 20 is formed at the dash panel 14. In the present exemplary embodiment, a wire harness 22 that electrically connects a motor and a battery, which are not illustrated in the drawings, is arranged along a surface 14A of the dash panel 14. The wire harness 22 is held by the clamp 20.

For example, the clamp 20 includes an upper claw piece (second claw portion) 24 and a lower claw piece (first claw portion) 26, and the upper claw piece 24 and the lower claw piece 26 are disposed facing each other vertically.

The lower claw piece 26 is substantially L-shaped, and includes a lower leg piece 28 that projects out toward the rear side from the surface 14A of the dash panel 14, and that has a cross-section shape that is substantially rectangular when taken along the up-down direction and the vehicle width direction, and a lower claw portion 30 that projects out upward from a leading end of the lower leg piece 28. Further, an inclined face 32, which is inclined toward a surface 14A side of the dash panel 14 while extending toward an upper side, is formed at a rear face 30A of the lower claw portion 30.

An amount that the lower leg piece 28 projects out is substantially the same length as an outer diameter dimension of the wire harness 22, and the wire harness 22 can be inserted between the surface 14A of the dash panel 14 and the lower claw portion 30. Further, an amount that the lower claw portion 30 projects out is larger than, for example, the outside diameter dimension of the wire harness 22. Therefore, the wire harness 22 can be housed and held inside a housing portion 34 that is configured by the surface 14A of the dash panel 14, the lower leg piece 28, and the lower claw portion 30.

In this manner, by projecting the lower claw portion 30 out at the leading end of the lower leg piece 28, the wire harness 22 is prevented, by the lower claw portion 30, from being pulled out in a state in which the wire harness 22 is housed inside the housing portion 34. It should be noted that it is sufficient that the wire harness 22 can be maintained in a state housed inside the housing portion 34, such that the amount that the lower claw portion 30 projects out need not necessarily be larger than the outer diameter dimension of the wire harness 22.

The upper claw piece 24 has a substantially inverted L-shape, and includes an upper leg piece 36 that faces the lower leg piece 28, that projects out toward the rear side from the surface 14A of the dash panel 14, and that has a cross-section shape that is substantially rectangular when taken along the vehicle up-down direction and the vehicle width direction, and an upper claw portion 38 that projects out downward from a leading end of the upper leg piece 36. Further, an inclined face 40, which is inclined away from the surface 14A of the dash panel 14 toward a lower side, is formed at a front face 38A of the upper claw portion 38.

In the present exemplary embodiment, the upper leg piece 36 projects out toward the rear side further than the lower leg piece 28, and the upper leg piece 36 is longer than the lower leg piece 28. Further, the upper claw portion 38 is formed at the rear side of the lower claw portion 30. Namely, the upper claw portion 38 and the lower claw portion 30 are formed in a state offset in the front-rear direction. Moreover, a gap 42 is provided between the inclined face 40 of the upper claw portion 38 and the inclined face 32 of the lower claw portion 30, and the gap 42 is formed slightly smaller than the outer diameter dimension of the wire harness 22.

The clamp 20 is integrally formed with the dash panel 14 that is made of a resin, and the upper claw portion 38 is formed longer than the lower claw portion 30, and is easily elastically deformed. Therefore, as illustrated in FIG. 1B, by elastically deforming the upper claw portion 38, the gap 42 is widened, and the wire harness 22 is capable of passing therethrough.

### Operation and Effects of the Vehicle Front Portion Structure

Next, explanation follows regarding operation and advantageous effects of the vehicle front portion structure according to the present exemplary embodiment.

As illustrated in FIG. 1A, the front portion of the vehicle 12 includes the dash panel 14 and the clamp 20, and the dash panel 14 is formed of a resin. The clamp 20 is integrally molded with the dash panel 14, and holds the wire harness 22 that is arranged at the dash panel 14.

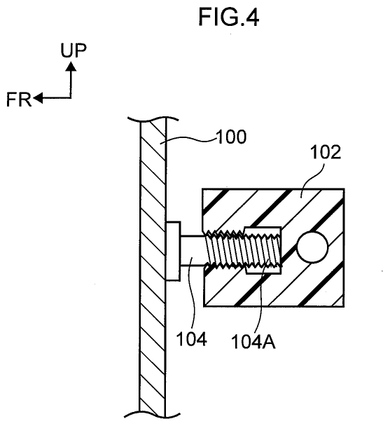

For example, as a comparative example, as illustrated in FIG. 4, in a case in which a clamp 102 is attached to a metal dash panel 100, a stud bolt 104 is first welded to the dash panel 100. The clamp 102 is then inserted into a threaded portion 104A of the welded stud bolt 104, and the clamp 102 is attached to the dash panel 100 via the stud bolt 104.

In contrast thereto, in the present exemplary embodiment, as illustrated in FIG. 1A, the dash panel 14 is molded from a resin, such that the clamp 20 can be integrally molded with the dash panel 14 that is made of a resin. This eliminates the need for auxiliary materials such as the stud bolt 104 that is used when attaching the clamp 102 to the dash panel 100 illustrated in FIG. 4 in the comparative example, thereby enabling the number of components to be reduced. Namely, in arranging the wire harness 22 at the dash panel 14, the number of components can be reduced.

There is no need to attach the clamp 20 to the dash panel 14, thereby enabling the number of work man-hours to be reduced correspondingly, and further enabling a cost reduction to be achieved.

In the present exemplary embodiment, the clamp 20 stands up from the surface 14A of the dash panel 14 and holds, together with the surface 14A of the dash panel 14, the wire harness 22, such that the wire harness 22 can be arranged along the surface 14A of the dash panel 14.

The clamp 20 includes the lower claw piece 26 and the upper claw piece 24, and the lower claw piece 26 holds the wire harness 22 between the lower claw piece 26 and the surface 14A of the dash panel 14. The upper claw piece 24 is formed facing the lower claw piece 26, and the gap 42 through which the wire harness 22 can pass is provided between the upper claw piece 24 and the lower claw piece 26.

Namely, the wire harness 22 is guided toward a lower claw piece 26 side through the gap 42 that is provided between the lower claw piece 26 and the upper claw piece 24, and the wire harness 22 is held between the lower claw piece 26 and the surface 14A of the dash panel 14. Therefore, in holding the wire harness 22 at the clamp 20, the wire harness 22 is simply passed through the gap 42, such that the wire harness 22 is easily attached and workability is excellent.

The upper claw piece 24 is formed so as to project out from the surface 14A of the dash panel 14 further than the lower claw piece 26. Therefore, it is easier for the upper claw piece 24 to be elastically deformed than the lower claw piece 26. As illustrated in FIG. 1B, the gap 42, through which the wire harness 22 can pass between the upper claw piece 24 and the lower claw piece 26, is formed due to elastic deformation of the upper claw piece 24.

Therefore, when the wire harness 22 passes between the upper claw piece 24 and the lower claw piece 26, the upper claw piece 24 is restored, and the size of the gap 42, which is formed between the upper claw piece 24 and the lower claw piece 26 and through which the wire harness 22 can pass, is at least reduced. As a result, the wire harness 22 is prevented from being pulled out, and the wire harness 22 that is held by the lower claw piece 26 can be prevented from being easily detached from the clamp 20.

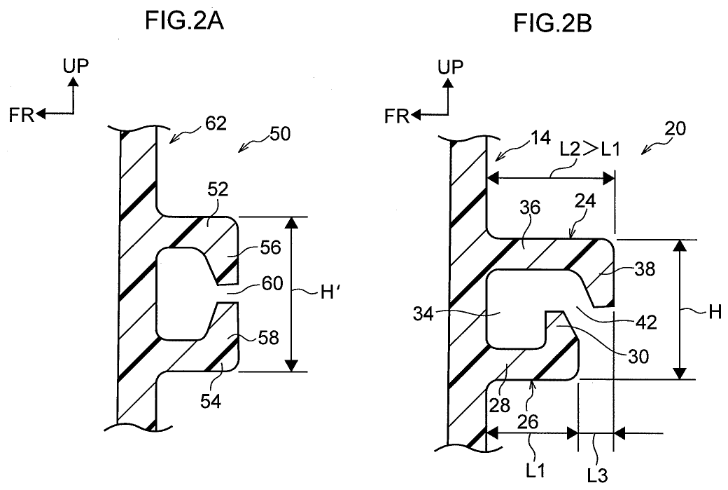

Forming a length (L2) of the upper claw piece 24 longer than a length (L1) of the lower claw piece 26, and the upper claw piece 24 being easily elastically deformed, enables the projection amount (L3) (offset in the front-rear direction) by which the upper claw piece 24 projects out further than the lower claw piece 26, as illustrated in FIG. 2B, to be made smaller.

Forming the upper claw portion 38 and the lower claw portion 30 in a state offset in the vehicle front-rear direction enables a dimension H (<H′) in the up-down direction to be shorter compared to a clamp 50 illustrated in FIG. 2A, as a modified example.

It should be noted that in FIG. 2A, an upper claw piece (second claw portion) 52 and a lower claw piece (first claw portion) 54 are formed with substantially the same length, and by elastically deforming the upper claw piece 52 and the lower claw piece 54, a gap 60 is formed between an upper claw portion 56 of the upper claw piece 52 and a lower claw portion 58 of the lower claw piece 54, thereby enabling the wire harness 22 (see FIG. 1B) to pass therethrough. In the clamp 50, the upper claw piece 52 and the lower claw piece 54 are formed with substantially the same length, thereby enabling a dimension in a plate thickness direction of a dash panel 62 to be reduced.

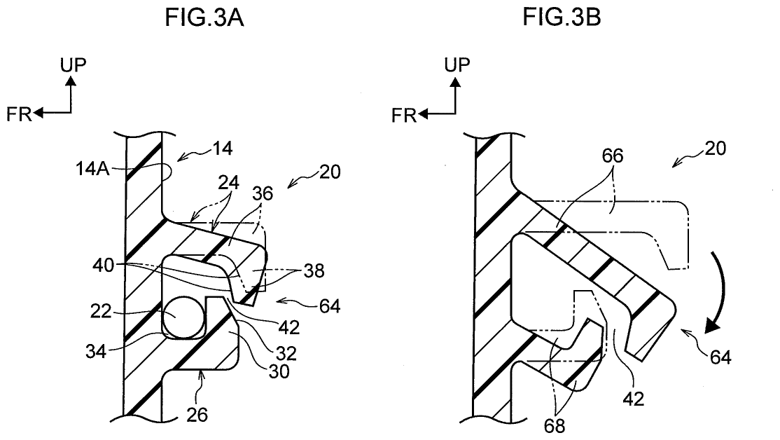

As illustrated in FIG. 3A, in the present exemplary embodiment, the upper claw portion 38 of the upper claw piece 24 and the lower claw portion 30 of the lower claw piece 26 are formed in a state offset in the front-rear direction, the gap 42 is provided between the inclined face 40 of the upper claw portion 38 and the inclined face 32 of the lower claw portion 30, and the wire harness 22 is capable of passing through the gap 42.

When the wire harness 22 passes through the inside of the gap 42, the wire harness 22 moves obliquely upward along the inclined surfaces 32 and 40, and after passing through the gap 42, the wire harness 22 passes between the upper leg piece 36 of the upper claw piece 24 and a leading end of the lower claw portion 30 of the lower claw piece 26, along a substantially horizontal direction. Further, when the wire harness 22 comes into contact with the surface 14A of the dash panel 14, the wire harness 22 moves downward and is housed inside the housing portion 34.

Namely, in the present exemplary embodiment, a labyrinth structure 64 is configured such that a path of the wire harness 22 is changed in the process until the wire harness 22 is inserted and held in the clamp 20.

In this manner, in the clamp 20 that holds the wire harness 22, configuring the labyrinth structure 64 enables the upper claw piece 24 to cover the lower claw piece 26 (to overlap in the front-rear direction) even when the clamp 20 is bent due to aging or the like, thereby enabling the wire harness 22 that is held by the lower claw piece 54 to be prevented from being easily detached.

In particular, in FIG. 3B, an upper claw piece 66 is formed longer than compared to FIG. 3A, and the bending amount is greater than in the upper claw piece 24 in FIG. 3A. The overlapping amount between the upper claw piece 66 and a lower claw piece 68 is increased correspondingly, and the wire harness 22 is less likely to detach.

It should be noted that in the above exemplary embodiment, as illustrated in FIG. 1A and FIG. 1B, although the upper claw piece 24 and the lower claw piece 26 are provided at the clamp 20, the upper claw piece 24 is not necessarily required.

Although an exemplary embodiment of the present disclosure has been explained above, the present disclosure is not limited to such exemplary embodiments, and an exemplary embodiment and various modified examples may be used in combination as appropriate, and obviously the present disclosure may be implemented in various modes within a range that does not depart from the scope of the present disclosure.

### ADDITIONAL NOTES

It should be noted that the vehicle front portion structure according to the present disclosure may be configured by appropriately combining the following configurations.

### Configuration 1

A vehicle front portion structure includes: a dash panel made of a resin and partitioning a power unit room from a vehicle cabin; and a clamp integrally formed with the dash panel and holding a wire harness that is arranged at the dash panel.

### Configuration 2

The clamp stands up from a surface at a vehicle cabin side of the dash panel and holds, together with the surface of the dash panel, the wire harness.

### Configuration 3

The clamp includes: a first claw portion that holds the wire harness between the first claw portion and the surface of the dash panel; and a second claw portion that is formed facing the first claw portion, and a gap, through which the wire harness can pass, is provided between the second claw portion and the first claw portion.

### Configuration 4

The second claw portion is formed projecting out from the surface of the dash panel further than the first claw portion; and the gap is deformed between the second claw portion and the first claw portion by elastic deformation of the second claw portion.

### Configuration 5

A path, through which the wire harness passes, is formed in a labyrinth structure between a leading end portion of the first claw portion and a leading end portion of the second claw portion.

What is claimed is:

1. A vehicle front portion structure, comprising:
a dash panel made of a resin and partitioning a power unit room of a vehicle from a vehicle cabin; and
a clamp integrally formed with the dash panel and holding a wire harness that is arranged at the dash panel.

2. The vehicle front portion structure according to claim 1, wherein the clamp stands up from a surface at a vehicle cabin side of the dash panel and holds, together with the surface of the dash panel, the wire harness.

3. The vehicle front portion structure according to claim 1, wherein the clamp comprises:
a first claw portion that holds the wire harness between the first claw portion and a surface of the dash panel; and
a second claw portion that is formed facing the first claw portion, and a gap, through which the wire harness can pass, is provided between the second claw portion and the first claw portion.

4. The vehicle front portion structure according to claim 3, wherein:
the second claw portion projects out from the surface of the dash panel further than the first claw portion; and
the gap is deformed between the second claw portion and the first claw portion by elastic deformation of the second claw portion.

5. The vehicle front portion structure according to claim 3, wherein a path, through which the wire harness passes, is formed in a labyrinth structure between a leading end portion of the first claw portion and a leading end portion of the second claw portion.
